(19) United States
(12) Patent Application Publication
(10) Pub. No.: US 2014/0374960 A1
(43) Pub. Date: Dec. 25, 2014

(54) METHOD FOR PRODUCING A GRAPHENE FILM

(71) Applicants: ECOLE POLYTECHNIQUE, PALAISEAU (FR); CENTRE NATIONAL DE LA RECHERCHE SCIENTIFIQUE- CNRS, PARIS (FR)

(72) Inventor: Costel-Sorin Cojocaru, Palaiseau (FR)

(21) Appl. No.: 14/359,894

(22) PCT Filed: Nov. 21, 2012
(86) PCT No.: PCT/EP2012/073272

§ 371 Date: May 21, 2014

(30) Foreign Application Priority Data
Nov. 22, 2011 (FR) 1160612

(51) Int. Cl. C01B 31/04

(52) U.S. Cl. CPC C01B 31/0453; C01B 2204/22
USPC 264/430; 264/81; 264/39

(57) ABSTRACT

A process for manufacturing graphene film, comprising the controlled growth of graphene film, comprises the following steps: depositing at least one metal layer on the surface of a substrate; and continuously producing a carbon-rich buried region inside said metal layer by bombarding the metal layer with a flux of carbon atoms and/or carbon ions with an energy higher than about a few tens of electron volts so that they penetrate a portion of the metal layer, allowing said carbon-rich region to be created and maintained, so as to form, by diffusion, through said metal layer, a graphene film at the interface of said metal layer with said substrate.

The field of the invention is that of processes for manufacturing very thin layers made of graphene. This type of generally conductive thin layer has the great advantage of being transparent and therefore of having many applications in the field of electronics and of displays because of the excellent properties, in terms of absorption and electrical conductivity, of this type of material.

Graphene is a two-dimensional carbon crystal formed from a monoatomic layer of sp2-hybridized carbon atoms (benzene ring structure corresponding to hexagonal cells), graphite being formed by sheets of graphene having a thickness corresponding to the size of a carbon atom. Although implicit in the construction of fullerenes, of carbon nanotubes and of graphite, graphene had never been isolated and studied. Its stability itself was contested, all thin crystals having a tendency to be thermodynamically unstable (the less bonded surface atoms becoming predominant over those of the bulk). Graphene films were first isolated in 2004, as described in the article by K. S. Novoselov et al. “Electric Field Effect in Atomically Thin Carbon Films”, Science, Vol. 306, p.666, 2004 and have proved to be remarkably stable. These films were obtained by “exfoliation” of HOPG (highly ordered pyrolytic graphite) graphite blocks, this HOPG material being commercially available. Graphite is a lamellar material formed from stacks of graphene sheets and the bonds between horizontal planes are weak. Exfoliation consists in removing graphene planes using adhesive tapes. The method is simple but not very reproducible; however, it allows graphene platelets measuring about 10 to a few tens of μm in one dimension to be obtained.

These first graphene sheets allowed graphene to be characterized and it to be demonstrated that it is a material that is stable, highly conductive and ambipolar (i.e. able to exhibit two types of conduction, by holes or by electrons; graphene is in fact a zero-bandgap semiconductor) and that exhibits high carrier (electron or hole) mobilities (of the order of 10,000 to 100,000 cm²/Vs at low temperatures).

Graphene may thus very advantageously be, on the one hand, applied to the fabrication of thin-film transistors (provided that ribbon width can be precisely controlled, so as to open an energy gap in the band structure of the material) and, on the other hand, used to provide thin transparent metallic films to replace ITO (indium tin oxide) in flat screens, in solar cells and generally in any application requiring a transparent conductor. The advantages of this material have been proven for films containing up to about four graphene monolayers (material denoted FLG, for “few-layer graphene”). These advantages are major advantages insofar as it is being sought to replace ITO because of the rarity and therefore expensiveness of indium.

However, in practical use it would seem difficult to employ the exfoliation method since the latter does not allow the thickness (i.e. the number of graphene layers) or the geometry of the deposit to be controlled with precision. Various preparation methods have been developed, such as for example partial graphene oxidation, which then makes exfoliation in an acid solution possible. The graphene is generally then placed in an aqueous suspension and deposited, for example by filtration or by spraying, with the problem that the layers obtained are not uniform in thickness.

In order to obtain acceptable electrical-conductivity values it is then necessary to reduce the graphene chemically (in order to remove interstitial oxygen). A process of this type, which is nevertheless highly complex, is described in the article by G. Eda et al. in Nature Nanotechnology, Vol 3, p. 270, 2008. Other synthesis methods that have been explored are epitaxial growth via high-temperature (above 1300° C.) annealing of silicon carbide substrates, such as described in the article by C. Berger, Science 312 (2006) 1191-1196, or the segregation of (epitaxial) surface carbon separated thermally from single-crystals of transition metals (i.e. ruthenium) doped with carbon (but that do not form carbides, such as described in the article by P Sutter, Nat Mater 7 (2008) 406-411).

At the present time, the most studied technique for synthesizing large-area graphene layers is vapor phase deposition on (thin-films or sheets of) polycrystalline metals, using a carbon-containing precursor such as methane for example. Once produced, these layers may be separated from the metal layer acting as a carrier by selective etching, and subsequently transferred to a substrate chosen depending on the intended application.

In order to make the rest of the description easier to understand, the principal processes that currently allow very thin films to be deposited in vacuum are now summarized.

One type of process used to deposit very thin films in vacuum is CVD (chemical vapor deposition), in which the constituent(s) of a gaseous phase react to form a film. The chemical reaction may be activated by plasma, this method is then referred to as PECVD (plasma-enhanced chemical vapor deposition)

Physical PVD (physical vapor deposition) processes are another type of process used to deposit very thin films in vacuum, these processes possibly employing a thermal technique, including the MBE (molecular beam epitaxy) process, or sputtering.

The Applicant has also filed a patent application FR 08/05769 for an original process for synthesizing graphene layers, which consists in using an intermediate layer of a metal having a limited solubility domain with carbon (for example nickel or copper), then in exposing this metal to a controlled flux of carbon or of a carbon precursor in a PECVD process, a gaseous precursor being used. It is also possible to use an ion-implantation process. Next, a controlled cooling step is carried out in order to precipitate graphene on the surface of the metal. In the case of the PECVD process, a graphene layer may be obtained at the metal/substrate interface. It is then not necessary to subsequently transfer the interface graphene layer to another substrate (this process step generally adversely affecting crystal quality).

More precisely, the subject of this patent application is a process for controllably growing graphene film, comprising the following steps:
producing, on the surface of a substrate, a layer of a metal having a phase diagram with carbon such that beyond a threshold molar concentration ratio C_{M}/(C_{M}+C_{C}), where C_{M} is the metal molar concentration in a metal/carbon mixture and C_{C} is the carbon molar concentration in said mixture, a homogenous solid solution is obtained;
exposing the metal layer to a controlled flux of carbon atoms or carbon-containing radicals or carbon-containing ions at a temperature such that the molar concentration ratio obtained is higher than the threshold ratio so as to obtain a solid solution of carbon in the metal; and
an operation allowing the phase of the mixture to be separated into two phases, a metal phase and a graphite phase, respectively, leading to the formation of at least one bottom graphene film at the interface between the metal containing the carbon atoms and the substrate, and to the formation of a top graphene film on the surface of the metal layer.

Other works subsequent to this patent application, notably carried out by Rice University (ACS Nano, Just Accepted Manuscript, DOI: 10.1021/nn202923y, Publication Date (Web): 3 Sep. 2011) (ACS Nano, Just Accepted Manuscript, DOI: 10.1021/nn202829y, Publication Date (Web): 2 Sep. 2011) describe the use of a solid carbon source (polymer) deposited on the substrate and encapsulated by a layer of nickel-based catalyst. Following a heat treatment at about 1000° C., the carbon is dissolved then segregated by the nickel layer to form two graphene films (a surface and interface film, respectively) as described in the aforementioned patent of the Applicant.

A second study carried out by a Taiwanese university (Nano Lett dx.doi.org/10.1021/n1201362n, Received: Apr. 23, 2011, Revised: Aug. 1, 2011) relates to CVD growth of graphene at a temperature of 900° C., directly on a dielectric substrate, using a similar approach to that described in the above patent of the Applicant, but exploiting a copper layer as a catalyst and as a source of carbon for the growth of interface graphene and for the diffusion of carbon (originating from gaseous precursors) through grain boundaries in the Cu layer.

The latter processes are either carried out a very high temperatures (900° C.-1000° C.) or are complex.

Generally, it may be concluded from all of the aforementioned prior art that the processes developed up to now remain high-temperature processes, at typically 900° C.-1000° C., to produce a material of serviceable quality.

Moreover, the processes developed up to now for synthesizing interface graphene are sequential processes comprising two steps: a step of incorporating carbon into a metal then a segregating step, since incorporation of carbon by ion implantation is still poorly understood and difficult to control to produce a well-controlled process and graphene with well-controlled features. The Taiwanese process is of more interest in this regard since the synthesis is continuous, but the fact that it relies on diffusion of carbon through grain boundaries in a polycrystalline metal layer greatly decreases its interest. Specifically, the graphene obtained is also polycrystalline, the size of its grains being set by the grain size of the copper layer used. Moreover, these authors recognize these substantial and inherent limitations, namely that it is not possible to form a continuous film at low temperatures (below 850° C.). When the temperature is above 950° C., the defect level in the film is also high. This could be due to the segregation of carbon species at the Cu/insulator interface that forms, this segregation occurring more rapidly than the graphitization (dx.doi.org/10.1021/n1201362n |Nano Lett. 2011).

It will also be noted generally, regarding the synthesis of graphene on the surface of a catalyst, whether the latter is a metal or the substrate itself (as described in the articles: Applied Physics Letters 98, 183106 (2011), Applied Physics Letters 98, 252107 (2011)), that in the CVD processes known from the literature and described above, the graphene is obtained following exposure of a catalytic surface, generally a metal layer made of nickel or copper, to a gaseous mixture containing a carbon precursor (methane, acetylene, alcohols, etc.), this exposure being carried out at temperatures ranging from 500-600° C. to about 1000° C.

The graphene layer forms on the surface of the metal via catalytic disassociation of carbon-containing species and “construction” of the graphitic unit cell with carbon atoms either originating from the gaseous phase or from resorption of atoms that have diffused into the metal and/or to the surface of the metal. Depending on the process, forming a continuous graphene layer on the surface of the metal may prevent additional carbon from being introduced into the metal, and the possible graphitic growth mainly continues with carbon originating from the gaseous phase. This has the advantage of inherently limiting the thickness of the deposited graphene layer, but remains very difficult to control.

For this reason, in this context, the subject of the present invention is a process for manufacturing graphene film comprising the controlled growth of graphene film, characterized in that it furthermore comprises the following steps:
depositing at least one metal layer on the surface of a substrate; and
continuously producing a carbon-rich buried region inside said metal layer by bombarding the metal layer with a flux of carbon atoms and/or carbon ions with an energy higher than about a few tens of electron volts so that they penetrate a portion of the metal layer, allowing said carbon-rich region to be created and maintained, so as to form, by diffusion, through said metal layer, a graphene film at the interface of said metal layer with said substrate.

According to one variant of the invention, a carbon-rich buried region is continuously produced by exposing the metal layer to a flux of carbon atoms and/or carbon ions having sufficient energy to penetrate a portion of the metal layer.

According to one variant of the invention, the metal layer being about a few hundred nanometers in thickness, the energy of the flux of carbon atoms and/or carbon ions is about a few tens to a few hundred electron volts.

According to one variant of the invention, the metal layer being about a few tens of nanometers in thickness, the bombardment is carried out at a temperature lower than about 500° C.

According to one variant of the invention, the flux of carbon atoms and/or carbon ions comprises dopant species such as boron or nitrogen.

According to one variant of the invention, the flux of carbon atoms and/or carbon ions has its dopant species modulated over time.

According to one variant of the invention, the metal may be nickel, or copper, or cobalt, or iron, or ruthenium.

Advantageously, alloys and multilayer systems may also be used. For example, it may be chosen to use a thin Ru layer at the interface with the substrate (Ru is known for a better compatibility with graphene in terms of lattice parameter) on which thin Ru layer a thin layer of Cu, Ni, Co or Fe is deposited (the latter layers being known for better catalytic activities with respect to CVD processes). In the latter case, the range of growth temperatures must be adjusted appropriately in order to prevent alloys from forming. Ternary systems may also be envisioned, for example with Ru at the interface to facilitate the formation of high-quality graphene, Ni as a top layer for a good catalytic activity and a good diffusion of carbon, and a very thin intermediate layer, for example made of Cu, for preventing Ni/Ru alloys from forming while allowing the carbon to diffuse.

According to one variant of the invention, the process comprises producing a multilayer structure comprising at least:
one interface layer enabling a good crystallographic compatibility (hexagonal structure, lattice parameters) with graphene, and for example comprising ruthenium; and
a top layer comprising nickel, or copper, or cobalt, or iron, or an alloy that has catalytic properties with respect to hydrocarbons.

According to one variant of the invention, the substrate may be made of glass, quartz, sapphire, alumina, or magnesium oxide.

According to one variant of the invention, said carbon-rich zone is continually produced by a PECVD growth process comprising the following steps:
creating a plasma comprising ionized carbon-containing species; and
bombarding said metal layer with said ionized carbon-containing species under the action of an electric field.

According to one variant of the invention, the PECVD growth process is carried out with a triode type reactor generating a flux of ionized species the energy of which may be modulated independently of the plasma generating parameters.

According to one variant of the invention, the PECVD growth process is carried out in the presence of a gaseous precursor comprising an oxidizing species.

According to one variant of the invention, said carbon-rich zone is continually produced by an MBE process with a charged gaseous beam of molecular methane and carbon ions.

According to one variant of the invention, the metal layer is deposited at a temperature below the temperature at which said metal and said substrate form an alloy.

According to one variant of the invention, the metal being nickel and the substrate being based on silicon oxide, the deposition temperature of said metal layer is comprised between about 400° C. and 500° C.

According to one variant of the invention, the process furthermore comprises a prior step of cleaning said substrate chemically and/or by ion bombardment in order to prevent potential dewetting of said metal layer, at the surface of said substrate.

According to one variant of the invention, the process comprises a step of chemically dissolving said metal layer in order to expose the graphene layer formed beforehand.

According to one variant of the invention, the manufacturing process is carried out on a hydrosoluble substrate, possibly made of a NaCl or KBr salt, enabling said metal layer and said substrate to be chemically dissolved in a single step, in order to expose the graphene layer formed beforehand in the form of a free membrane that may be suspended.

The invention will be better understood and other advantages will become apparent on reading the following description and by virtue of the appended figures, in which:

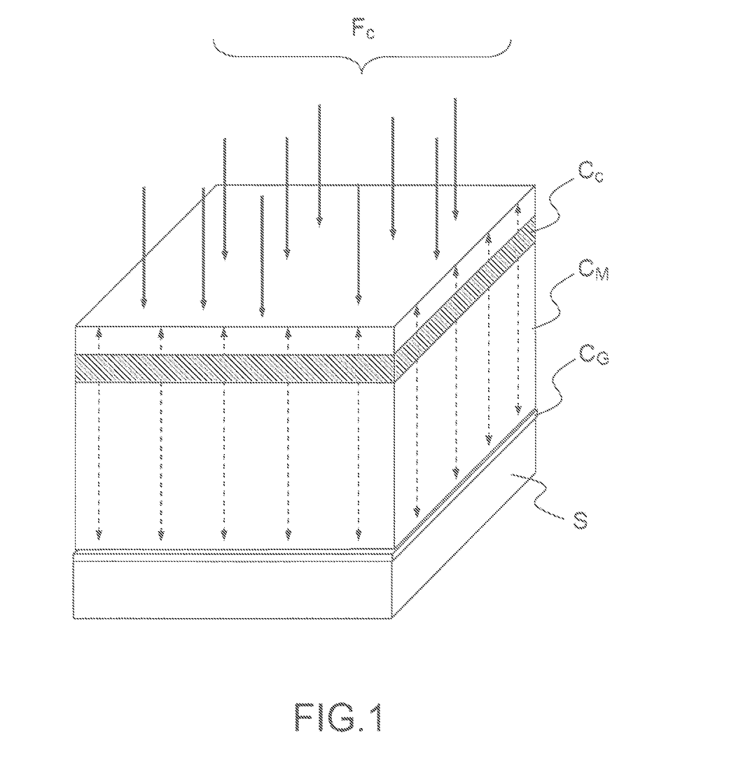

FIG. 1 illustrates the structure obtained according to the process of the present invention, which notably comprises producing a region rich in carbon atoms inside a metal layer;

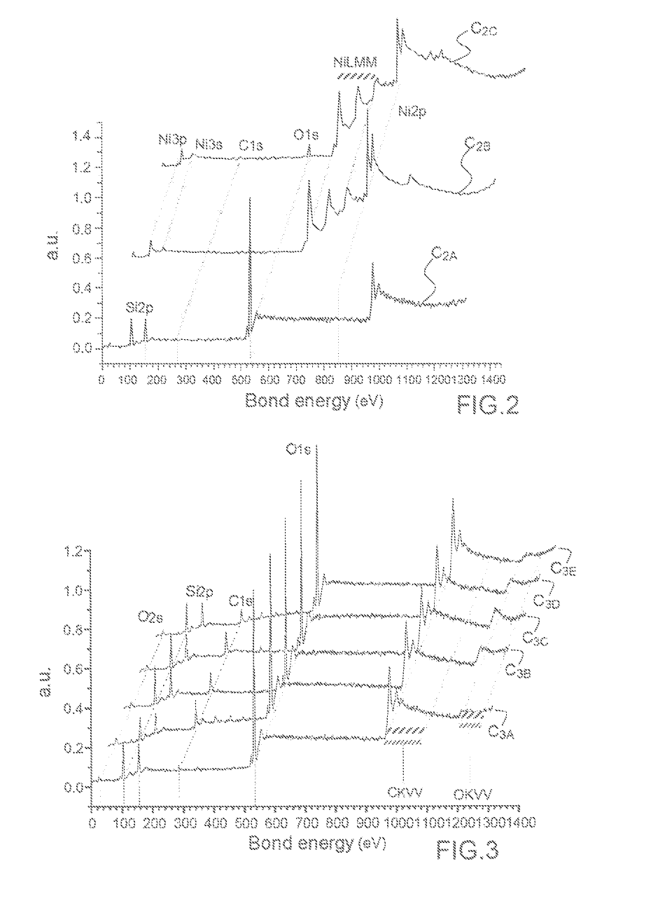

FIG. 2 illustrates the results of XPS spectroscopy analysis of a bare substrate, a substrate covered with a nickel layer, and of a substrate covered with a graphene film produced according to the process of the invention, respectively;

FIG. 3 illustrates the results of XPS spectroscopy analysis of graphene film obtained according to the process of the invention and produced on various substrates;

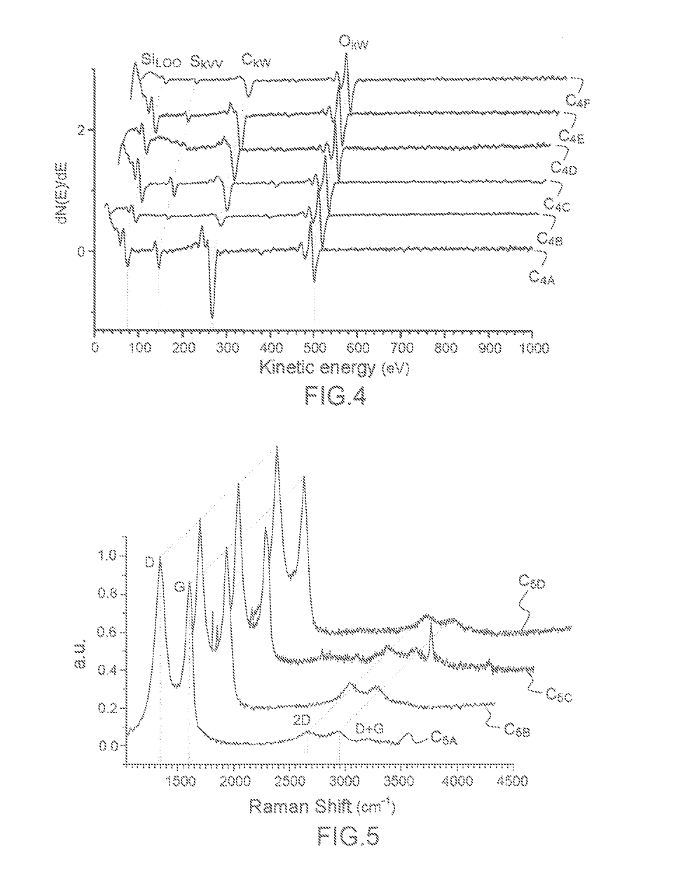

FIG. 4 illustrates the results of Auger spectroscopy analysis of graphene film obtained according to the process of the invention and produced on various substrates;

FIG. 5 illustrates the results of Raman spectroscopy analysis of graphene film obtained according to the process of the invention and produced on various substrates; and

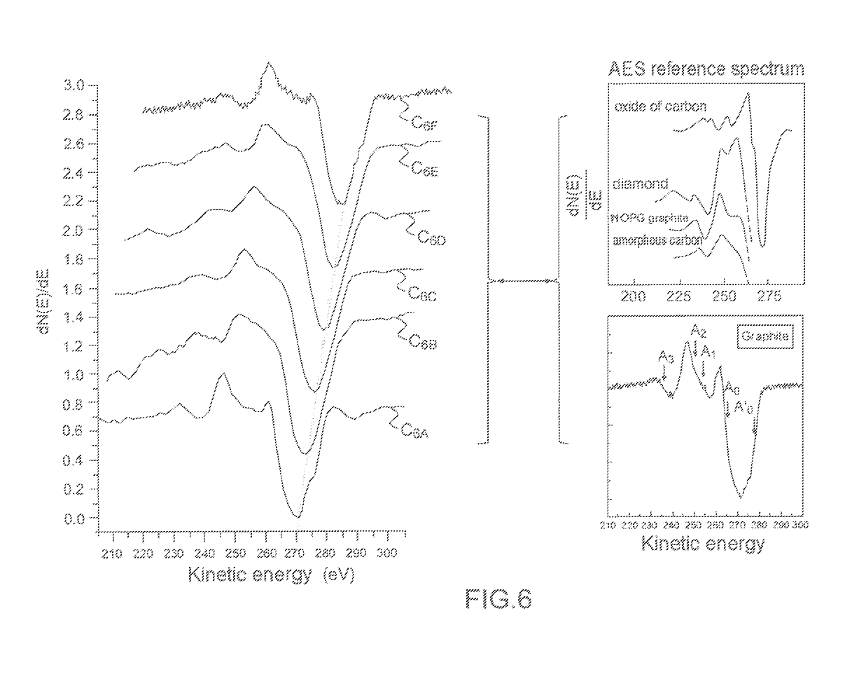

FIG. 6 illustrates the results of AES spectroscopy analysis of graphene film obtained according to the process of the invention and produced on various substrates.

The process for manufacturing a graphene film according to the invention comprises a process step of controllably growing graphene, which step involves depositing a metal layer, notably one possibly made of nickel, or cobalt, or iron, or copper, or ruthenium.

This layer is deposited on a substrate of interest (possibly made of glass, quartz, sapphire, alumina, MgO, etc.) the choice of which is only constrained by the fact that, in the temperature range used for the deposition, the substrate must not form an alloy with the metal layer.

The process of the present invention is based on the ability to create and maintain, in this metal layer, a carbon-rich region as illustrated in FIG. 1, which shows: on a substrate S, and in a metal layer C_{M}, the presence of a region C_{C} rich in carbon-containing species, in order to obtain a carbon concentration gradient that makes it possible to promote the diffusion of carbon-containing species by interaction of a flux FC of said carbon-containing species directed towards the interface with the substrate and their segregation/precipitation to form graphene, thus allowing a graphene film to be formed at the metal layer/substrate interface

The carbon-rich region may be created and maintained at various synthesis temperatures throughout the deposition, for example using a plasma-enhanced chemical vapor deposition (PECVD) growth process, or an ion implantation or molecular beam epitaxy (MBE) process or a combination of both, as will be described in greater detail below in the rest of the description. The relative distance from the surface of the metal layer at which the carbon-rich region is created and maintained depends on the energy and flux of the carbon atoms/ions used.

More precisely, in the case of a PECVD process, the carbon-containing species may be ionized in a plasma then directed toward the substrate by an electric field (obtained for example by biasing the substrate). If the energy of the ions is suitably chosen, it becomes possible to implant the carbon in a region near the surface of the metal layer and thus create a carbon-rich region the depth of which depends on the energy of the ions, whereas the carbon concentration obtained depends on the ion flux.

The ion flux that permanently bombards the surface of the metal layer prevents a continuous carbon (and possibly graphitic) layer from forming on this surface from carbon rediffusing toward the surface of the substrate and from carbon deposited from the gaseous phase (as in conventional CVD processes).

Moreover, if a triode type PECVD reactor configuration is used, the energy of the ions and the ion flux may be modulated independently of the parameters used generating and maintaining the plasma (created between two electrodes) via the biasing potential applied to the substrate (the third electrode). It thus becomes possible to controllably influence the thickness of the graphene layer synthesized (number of graphitic planes).

Is also possible to use an ion implantation process (a commercial ion implantation process or one such as described below), or an MBE process or even a combination of these two processes. In this case, a carbon-rich region is created and maintained, the relative distance of the carbon-rich region from the surface of the metal layer depending on the energy and flux of the carbon atoms/ions used.

It will be noted that in this process the continuous formation of graphene on the surface of the metal is to be avoided because this may prevent the supply of carbon to the carbon-rich region that it is desired to create in the metal layer.

Thus, the proposed process allows graphene layers to be obtained directly on substrates of interest (growth at the interface) in a single step (continuous and controllable growth).

Moreover, the thickness of the synthesized graphene layer (the number of graphitic planes) may be modulated mainly by the exposure time (or the flux (dose) of carbon atoms implanted into the metal layer) and the implantation depth (correlated both with the energy of the implanted species and with the diffusion length of the carbon atoms to the interface, which is related to the temperature and the thickness of the metal layer).

The process of the present invention also has the advantage of inherently making it possible:
to synthesize, controllably and simply, doped graphene films by adding dopant elements (for example nitrogen or boron) to the gas source; and
to synthesize, in a single manufacturing step, films with modulated doping by changing during the deposition the type of the doping elements.

### Example Process for Manufacturing a Graphene Film According to the Invention and Validation of Graphene Film Being Obtained

Various types of substrates made of silicon oxide in various forms were used: glass (softening point near 550° C.), quartz, fused quartz (softening point near 800° C.) and thermal silicon dioxide on a (100) Si silicon wafer.

A layer of about 100 nm of nickel was deposited by evaporation under an ultra-high vacuum on a substrate heated to 450° C., temperature generally equal to that subsequently used for the synthesis of the graphene. This method (depositing nickel hot and not at room temperature) is selected in order to avoid possible dewetting of the nickel layer after the increase to the synthesis temperature.

Prior to the nickel deposition, the substrates were cleaned chemically, then under vacuum in a UHV (ultra-high vacuum) reactor by ion bombardment of Ar⁺ ions, in order to eliminate any trace of contaminants (including carbon) at the interface. The surface quality was monitored in each step by X-ray photoelectron spectroscopy (commonly referred to as XPS spectroscopy), Auger spectroscopy or even Raman spectroscopy techniques.

The substrates thus prepared were then:
transferred into a triode type PECVD reactor and exposed to a CH₄ (30% H₂) plasma for 3 minutes, typically at a temperature of 450° C. On glass, two other synthesis temperatures of 500° C. and 550° C. were tested. During the deposition, from the main plasma, an ion current of about 0.6 A/cm² was extracted with an extraction potential applied to the substrate of 100 V. A cleaning plasma was then applied at the end of the deposition, for 10 minutes, at a temperature of 100 to 160° C. in order to remove any possible carbon deposited on the surface of the samples; and
kept in the UHV reactor and exposed hot (at 450° C.) to an (MBE type) gaseous beam containing (molecular) methane and carbon and methane ions and a small proportion of hydrogen originating from the disassociation of the CH₄. This beam was generated using a commercially available ion bombardment source. The energy of the ions, the degree of ionization and the flux could be modulated with precision over a wide range (namely from 100 eV to more than 3 keV±2 eV, from 0.05 to a few tens of μA/cm², partial pressure in the beam from 10⁻² to 10⁻⁷ mbar).

An ion energy of 250 eV, corresponding to the average energy of the ions typically extracted from a (triode) PECVD plasma such as described above, was chosen, the ion flux was set to 15 μA/cm² in order to obtain for a 120-minute long exposure an equivalent “dose” to that obtained during the 3-minute long exposure in the triode PECVD process described above (N.B. a flux of 0.6 mA/cm² was used in this case).

After the two types of deposition, the nickel layer was removed by wet etching (commercially available Ni etchant: Nickel Etchant TFB from Transene). In all cases, the formation of an interface graphene layer originating from carbon having passed through the nickel layer from the gas source was demonstrated by electron spectroscopy (XPS and Auger spectroscopy) and by Raman spectroscopy.

These results are presented in greater detail below.

XPS analysis was applied to:
the surface of a substrate (less than 10 nm of depth analysed) after cleaning (curve C_{2A} in FIG. 2, the x-axis relates to bond energy and the y-axis is in arbitrary units);
to the substrate plus the deposited nickel layer (curve C_{2B} in FIG. 2); and
to the substrate plus the graphene film and the Ni layer after a complete interface-graphene synthesising process (including the removal of residual carbon from the surface of the nickel layer) (curve C_{2C} in FIG. 2). The absence of carbon will be noted (removal of residual carbon from the surface of the nickel layer), indicating that if, after dissolution of the nickel layer, carbon is detected in graphene form its presence at the interface is related to diffusion through the nickel layer, which keeps its integrity (not to diffusion at grain boundaries).

Another XPS analysis was carried out on the graphene film produced on the various substrates after graphene synthesis and dissolution of the nickel layer, these various substrates were respectively:
a quartz substrate (softening point above 1000° C.) and PECVD growth process at 450° C. (curve C_{3A} in FIG. 3);
a glass substrate (softening point 550° C.) and PECVD growth process at 450° C. (curve C_{3B} in FIG. 3);
a substrate of thermal silicon oxide on an Si (100) substrate (SiO₂/Si) and MBE growth process with implantation of 250 eV carbon ions at 450° C. (curve C_{3D} in FIG. 3);
a fused quartz (fused SiO₂) substrate and PECVD growth process at 450° C. (curve C_{3D} in FIG. 3); and
a glass substrate (softening point 550° C.) with a PECVD growth process at 550° C. (curve C_{3E} in FIG. 3).

Carbon was observed to be present in all the samples, independently of the type of interface and of the type of growth process (PECVD or MBE). The graphitic nature (graphene) of the carbon layer formed on the surface of a substrate using the process of the invention was confirmed by the curves in FIGS. 4 (the x-axis relates to kinetic energy and the y-axis is in arbitrary units) and 5, which figures were obtained by Auger (AES) and Raman spectroscopy, respectively.

More precisely, the AES analysis of the surface (grazing incidence of the electron beam enabling analysis over less than 2 nm of depth) of the samples after interface-graphene synthesis and dissolution of the nickel layer, respectively was made. The presence of graphitic carbon on the various substrates tested will be noted. The curves respectively relate to substrates of glass with a PECVD growth process at 450° C. (curve C_{4E}), at 500° C. (curve C_{4A}) and at 550° C. (curve C_{4B}), of fused quartz (fused SiO₂) with a PECVD growth process at 450° C. (curve C_{4C}), of SiO₂/Si with an MBE growth process with implantation of 250 eV carbon ions at 450° C. (curve C_{4D}), and of quartz with a PECVD growth process at 450° C. (curve C_{4F}).

The graphene nature of the layer (presence of the 2D band near 2700 cm⁻¹) was confirmed by the Raman analysis illustrated by the curves in FIG. 5. The curves C_{5A}, C_{5B}, C_{5C}, C_{5D} respectively relate to substrates of SiO₂/Si and an MBE growth process with implantation of 250 eV carbon ions at 450° C., and of SiO₂/Si, glass and quartz with a PECVD growth process at 450° C., respectively.

The confirmation of the presence of graphene was reinforced by fine AES analysis of the carbon, illustrated by the curves in FIG. 6, clearly indicating the graphitic nature of the deposit. The very small thickness of the (FLG graphene) layer was confirmed by the transparency of the deposit (it will be recalled that a graphene monolayer absorbs 2.3% and ten layers 23%). The curves in FIG. 6 respectively correspond to substrates of glass with a PECVD growth process at 450° C. (curve C_{6E}), at 500° C. (curve C_{6A}) and at 550° C. (curve C_{6B}), of fused quartz (fused SiO₂) and a PECVD growth process at 450° C. (curve C_{6C}), of SiO₂/Si and an MBE growth process with implantation of 250 eV carbon ions at 450° C. (curve C_{6D}), and of quartz with a PECVD growth process at 450° C. (curve C_{6F}).

It will be noted that by choosing suitable experimental conditions, the (UHV) MBE process may reproduce the growth conditions of the triode PECVD process (the graphene layers obtained are very comparable).

The triode PECVD process is a process that is rapid and very easily integrated into an industrializable flow. The growth process conditions in this case are reproducible and effective but the field of parameters to optimize is very large (typically more than fourteen sometimes interdependent parameters). Nevertheless, the fact that it is possible to reproduce the triode PECVD environment in a UHV process is a major advance for the following reasons:
a general synthesis mechanism may be envisioned;
the UHV process is a slower process and, inherently, extremely clean (residual vacuum of 10¹¹ mbar), precise and reproducible (known characteristics for example in MBE approaches);
using the UHV process, it is possible to explore a very wide range of environments and growth conditions with unparalleled control and reproducibility of each parameter. This makes it possible to engineer growth process conditions to obtain the best possible quality graphene for a given substrate and growth temperature; and
operating conditions developed with the precision and level of understanding inherent to the UHV process may be very easily transposable to the triode PECVD process. Therefore, both a very valuable tool for studying/developing processes via the UHV approach, and a simpler and more rapid synthesis process (triode PECVD) are obtained, it being possible to directly implement in the second approach improvements developed with the first approach.

1. A process for manufacturing graphene film comprising the controlled growth of graphene film, comprising:
depositing at least one metal layer on the surface of a substrate: and
continuously producing a carbon-rich buried region inside said metal layer by bombarding the metal layer with a flux of carbon atoms and/or carbon ions with an energy higher than about a few tens of electron volts so that they penetrate a portion of the metal layer, allowing said carbon-rich region to be created and maintained, so as to form, by diffusion, through said metal layer, a graphene film at the interface of said metal layer with said substrate.

2. The process for manufacturing graphene film as claimed in claim 1, wherein, the metal layer being about a few hundred nanometers in thickness, the energy of the flux of carbon atoms and/or carbon ions is about a few tens to a few hundred electron volts.

3. The process for manufacturing graphene film as claimed in claim 2, wherein, the metal layer being about a few tens of nanometers in thickness, the bombardment is carried out at a temperature lower than about 500° C.

4. The process for manufacturing graphene film as claimed in claim 1, wherein the flux of carbon atoms and/or carbon ions comprises dopant species such as boron or nitrogen.

5. The process for manufacturing graphene film as claimed in claim 4, wherein the flux of carbon atoms and/or carbon ions has its dopant species modulated over time.

6. The process for manufacturing graphene film as claimed in claim 1, wherein the metal may be nickel, or copper, or cobalt, or iron, or ruthenium or an alloy of these metals.

7. The process for manufacturing graphene film as claimed in claim 1, comprising producing a multilayer structure comprising at least one interface layer enabling a good crystallographic compatibility with graphene, for example a ruthenium layer, and a top layer of nickel, or copper, or cobalt, or iron, or of an alloy that has catalytic properties with respect to hydrocarbons.

8. The process for manufacturing graphene film as claimed in claim 1, wherein the substrate may be made of glass, quartz, sapphire, alumina, or magnesium oxide.

9. The process for manufacturing graphene film as claimed in claim 1, wherein said carbon-rich zone is continually produced by a PECVD growth process comprising the following steps:
creating a plasma comprising ionized carbon-containing species; and
bombarding said metal layer with said ionized carbon-containing species under the action of an electric field.

10. The process for manufacturing graphene film as claimed in claim 9, wherein the PECVD growth process is carried out with a triode type reactor generating a flux of ionized species the energy of which may be modulated independently of the plasma generating parameters.

11. The process for manufacturing graphene film as claimed in claim 10, wherein the PECVD growth process is carried out in the presence of a gaseous precursor comprising an oxidizing species.

12. The process for manufacturing graphene film as claimed in claim 1, wherein said carbon-rich zone is continually produced by an MBE process with a charged gaseous beam of molecular methane and carbon ions.

13. The process for manufacturing graphene film as claimed in claim 1, wherein the metal layer is deposited at a temperature below the temperature at which said metal and said substrate form an alloy.

14. The process for manufacturing graphene film as claimed in claim 13, wherein said metal layer is deposited at a temperature equal or near to the temperature used to grow the graphene film, in order to prevent possible dewetting effects.

15. The process for manufacturing graphene film as claimed in claim 1, further comprising a prior step of cleaning said substrate chemically and/or by ion bombardment in order to prevent any potential contamination of the interface between said metal layer and the surface of said substrate.

16. The process for manufacturing graphene film as claimed in claim 1, further comprising chemically dissolving said metal layer in order to expose the graphene layer formed beforehand.

17. The process for manufacturing graphene film as claimed in claim 1, the process being carried out on a hydrosoluble substrate, possibly made of a NaCl or KBr salt, enabling said metal layer and said substrate to be chemically dissolved in a single step, in order to expose the graphene layer formed beforehand in the form of a free membrane that may be suspended.
